(19) United States
(12) Patent Application Publication
(10) Pub. No.: US 2017/0181919 A1
(43) Pub. Date: Jun. 29, 2017

(54) Walking Assist Device

(71) Applicants: Do-Yoon Kim, Ulsan (KR); Sun Young Park, Ulsan (KR)

(72) Inventors: Do-Yoon Kim, Ulsan (KR); Sun Young Park, Ulsan (KR)

(73) Assignee: Do-Yoon Kim, Ulsan (KR)

(21) Appl. No.: 15/313,830

(22) PCT Filed: Feb. 17, 2015
(86) PCT No.: PCT/KR2015/001629

§ 371 Date: Nov. 23, 2016

(30) Foreign Application Priority Data
Aug. 13, 2014 (KR) 10-2014-0105114

(51) Int. Cl. A61H 3/04

(52) U.S. Cl. CPC A61H 3/04; A61H 2201/1642

(57) ABSTRACT

The present invention relates to a walking assist device which has been devised to provide a completely different type of walking assist device in effort to resolve the shortcomings or inconveniences in use of the conventional devices. The walking assist device of the present invention is provided with a main walker unit having a body member with a hollow portion in which a main walker's foot can be penetrated and fixed; and a sub-walker unit that is interconnected with said main walker unit and fixes a sub-walker's foot.

### CROSS-REFERENCE TO RELATED APPLICATION

This Application is a Section 371 National Stage Application of International Application No. PCT/KR2015/001629 filed Feb. 17, 2015, the contents of which is hereby incorporated by reference in its entirety.

### TECHNICAL FIELD

The present invention relates to a walking assist device and more particularly, a walking assist device by which a main walker who has no inconvenience in walking can help an inconvenient sub-walker take the walking practice.

### BACKGROUND OF THE INVENTION

As an example, a walking assist suit has been used in order for a main walker to assist the walking practice of a sub-walker.

The walking assist suit is provided with a band at the shoulder part so that a main walker can grab said band of the suit that a sub-walker is wearing and apply force to help a sub-walker get up. In this way, a sub-walker can be helped to reduce the weight burden and readily take the walking practice.

However, such walking assist suit has the following disadvantages or inconveniences.

First, since the main walker has to keep applying force to lift up, the main walker gets tired easily making it hard to take the walking practice for long enough time.

Secondly, it has risk that the main walker's step is out of the sub-walker's step and both walkers may fall down.

Thirdly, when the main walker lifts up the suit, the lower part of sub-walker's body is tightened and pressured causing inconvenience to the sub-walker, and the sub-walker may feel pain in the long time and even get wounded.

(Prior art) Korea registered patent 10-1403024

### SUMMARY OF THE INVENTION

Accordingly, the present invention has been made to solve the aforementioned problems occurring in the related art, and it is an object of the present invention to provide a new walking assist device that can significantly reduce the fatigue of the main walker, improve the safety, and cause no inconvenience to the sub-walker in using the same.

### Technical Solution

To achieve the above and other objects, in accordance with an embodiment of the present invention, there is provided a walking assist device comprising; a main walker unit having a body member with a hollow portion in which a main walker's foot can be penetrated and fixed; and a sub-walker unit that is interconnected with said main walker unit and fixes a sub-walker's foot.

Said main walker unit is provided with a harness that can adjust a hollow portion size to be fit for a main walker's foot.

Said main walker unit is provided with a base member that protrudes into one side of said body member, and said sub-walker unit is installed on the upper side of the same.

A support member is installed at the end part of said base member in the opposite direction of said body member and supports the load applied downward from said sub-walker unit.

A rotation prevention means is provided between the bottom side of said sub-walker unit and the upper side of the base member of said main walker unit so as to prevent the relative rotation between the sub-walker unit and the main walker unit after the sub-walker unit is installed at the upper side of the base member.

A clamping boss or an insertion hole are formed at the bottom side of sub-walker unit while a clamping boss or an insertion hole are formed at the upper side of said base member corresponding to said clamping boss or said insertion hole, and make interconnection. Said rotation prevention means is configured with a first and a second concavo-convex parts that are formed around said clamping boss and said insertion hole and interlocked with each other when the sub-walker unit is installed on the upper side of the base member.

Said harness is provided with a housing that is installed on the body member while covering one side cut out of the body member of said main walker unit with through screw hole formed at one side, a adjust bolt that is inserted into said through screw hole and moves forward and backward through one side cut out of the body member, and a pressure plate that is interconnected with the end part of said adjust bolt and gets in touch with the one side of the user's foot as said adjust bolt is tightened.

A wheel is installed at the bottom of said support member.

### Advantageous Effect

According to the embodiment of the present invention having the above-described configuration, the walking practice for long time is possibly made since the practice can be done only by the walking of the main walker while the power of main walker is taken less and the fatigue is reduced. In addition, because both the main walker unit and sub-walker unit moves together, there is no risk that the main walker's step is out of the sub-walker's step and both walkers fall down. Also, since the practice is taken at the step and rhythm of the main walker, the sub-walker can be mentally stabilized. Also, as opposed to the walking assist suit, there is no inconvenience to the sub-walker associated with wearing and using the suit. Moreover, since the main walker can take the control of walking, the practice proper to the state of sub-walker is made possible.

### BRIEF DESCRIPTION OF THE DRAWINGS

FIG. 1 is the perspective view of the walking assist device according to an embodiment of the present invention.

FIG. 2 is the end view of the body member of main walker unit of the walking assist device illustrated in FIG. 1.

FIG. 3 is the exploded perspective view demonstrating the interconnectivity between the main walker unit and the sub-walker unit in the walking assist device illustrated in FIG. 1.

FIG. 4 is the exploded perspective view showing the interconnection of the support member in the walking assist device illustrated in FIG. 1.

*Explanation of reference numerals for main parts in the drawing

| | |
|---|---|
| 10: main walker unit | 400: through hole |
| 100: body member | 50: support member |
| 100′: hollow portion | 500: support fixture |
| 120: cushion material | 500a: insertion slot |
| 120′: pressure plate | 500b: through hole |
| 20: sub-walker unit | 520: wheel |
| 30: harness | 60: rotation prevention means |
| 300: harness housing | 600: insertion hole |
| 300a: through screw hole | 610: clamping boss |
| 320: packing | 620: first concavo-convex part |
| 340: adjust bolt | 630: second concavo-convex part |
| 40: base member | 640: clamping bolt |

### DETAILED DESCRIPTION OF THE INVENTION

Hereinafter, according to a preferred embodiment of the present invention will be described in detail with reference to the accompanying drawings. The line thickness or the element size could be exaggeratedly shown for the clear description. The terminology used hereinafter is defined in consideration of the function in the present invention and can be varied according to the users, operator's intention or practices. Therefore, the definition of the terminology should be understood based on the overall contents of the present specification.

In addition, the following embodiments are not intended to limit the claims of the present invention but are only examples of the elements described in the claims of the present invention. Accordingly, various equivalent modifications and variations of the embodiments can be included in the scope of the present invention as recited in the claims.

FIG. 1 is the perspective view of the walking assist device according to an embodiment of the present invention. Referring to FIG. 1, the walking assist device according to the preferred embodiment of the present invention comprises the main walker unit (10) that the main walker wears and the sub-walker unit (20) that the sub-walker wears.

The main walker unit (10) is provided with the body member (100) having the hollow portion (100′) in which the main walker's foot can be penetrated and fixed while the sub-walker unit (20) is interconnected with said main walker unit (10) and fixes the foot of the sub-walker.

Although the main walker unit (10) could be made in the form of shoes so that the main walker can put on, the tube form as shown in the figure such that the foot of main walker can be penetrated and fixed is preferable in that the removal can be made conveniently and the various main walkers with different foot sizes can use the same walking assist device.

Thus, since the practice can be done only by the walking of the main walker as the main walker unit (10) and the sub-walker unit (20) is interconnected, the power of main walker is taken less with the fatigue reduced and the walking practice for long time is possibly made.

In addition, because both the main walker unit and sub-walker unit is interconnected, the unit movement is in sync with each other and both units move together, which removes the safety risk that the main walker's step is out of the sub-walker's step and both walkers fall down. Also, since the practice is taken at the step and rhythm of the main walker, the sub-walker can take the practice under the mentally stable state.

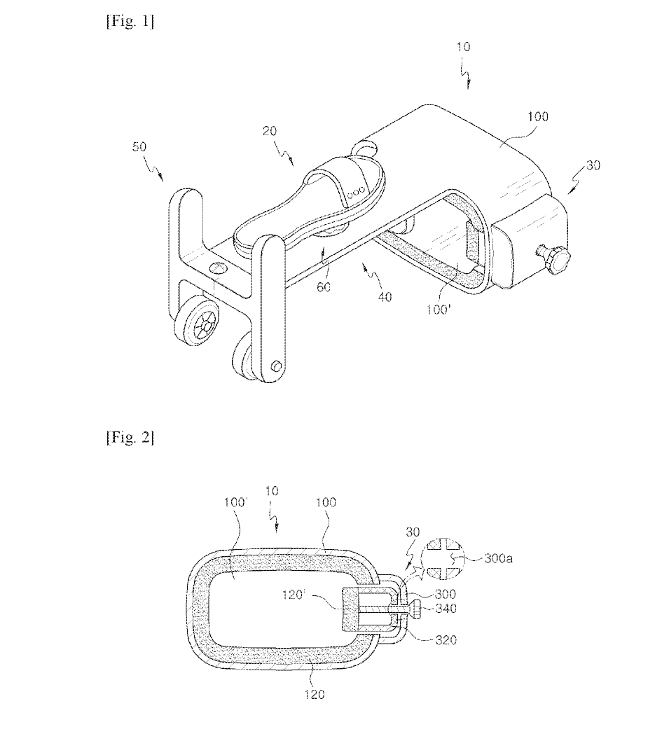

FIG. 2 is the end view of the body of main walker unit of the walking assist device illustrated in FIG. 1.

As shown in FIG. 2, the main walker's foot is penetrated and fixed in said hollow portion (100′) of the main walker unit (10). It is preferable to provide the harness (30) in said main walker unit (10) to adjust the hollow portion (100′) size of said body member (100) to be fit for the main walker's foot so that the various main walkers of different foot sizes can use the same walking assist device.

The any configuration of the harness (30) can be employed as long as it can adjust the hollow portion (100′) size of the body member (100). For example, the simple configuration may be considered such that one side of the body member (100) of the main walker unit (10) is completely cut out in the width direction, the bolt is put through the top and bottom of the cut out part, and the end part of bolt is clamped with the nut. In this configuration, the size of the hollow portion (100′) is adjusted to the main walker's foot as the width of the cut out part varies with the tightening degree of the nut while the main walker's foot is pressed in the up and down direction.

In another configuration, said harness (30) is preferably provided with the harness housing (300) that is installed on the body member (100) while covering one side cut out of the body member (100) of said main walker unit (10) with through screw hole (300a) formed at one side, the adjust bolt (340) that is inserted into said through screw hole (300a) of said harness housing (300) and moves forward and backward through one side cut out of the body member (100), and the pressure plate (120′) that is interconnected with the end part of said adjust bolt (340) and gets in touch with the one side of the user's foot as said adjust bolt (340) is tightened. At the inner side of the hollow portion (100′) of the body member (100) is installed the cushion material (120) to protect the main walker's foot and improve the wearing sensation. The same cushion material is also applied to said pressure plate (120′) at the end part of the hollow portion (100′). At the other end part of the hollow portion (100′) is installed the packing (320) of elastic material to prevent the foreign substances from getting in one side cut out of the body member (100) and not to disturb the movement of the pressure plate (120′) by the operation of the adjust bolt (340).

In this configuration, if the adjust bolt (340) is tightened properly after the main walker's foot is inserted into the hollow portion (100′) of the body member (100), the pressure plate (120′) moves forward pressing the side part of the foot and makes the foot stay in. The movement of the pressure plate (120′) varies with the tightening degree of the adjust bolt (340) and thus the various adjustments can be made.

The various configurations can be considered to interconnect the sub-walker unit (20) with said main walker unit (10). For example, the base member (40) protruding from one side of the body member (100) of the main walker unit (10) is provided and the sub-walker unit (20) is installed on the upper side of the base member.

The sub-walker unit may have any configuration to fix the sub-walker's foot. For example, it may be configured with the appearance similar to the shoes as shown in the figure.

The various configurations are possible to interconnect the main walker unit (10) with sub-walker unit (20). The main walker unit (10) can be simply formed in one body with the sub-walker unit (20), or both units can be separated and attached together using the adhesive.

In another configuration, the sub-walker units (20) having different sizes can be used by alternation, or the removal configuration can be employed for the replacement when the sub-walker unit (20) is damaged.

In the removal configuration, it is preferably provided with the rotation prevention means between the bottom side of said sub-walker unit (20) and the upper side of the base member (40) of said main walker unit (10) so as to prevent the relative rotation between the sub-walker unit (20) and the main walker unit (10) after the sub-walker unit (20) has been installed at the upper side of the base member (40), because the main walker unit (10) and the sub-walker unit (20) have to keep the interconnection side by side for the full performance of the walking assist device.

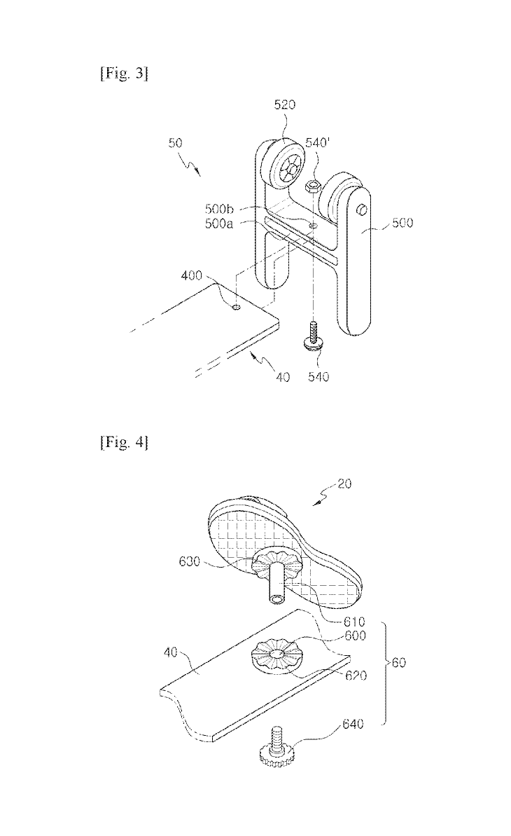

The various configurations may be considered for the rotation prevention means, e.g. the rotation prevention means (60) as shown in FIG. 3.

As shown in FIG. 3, if the configuration is selected such that the insertion hole (600) is formed at the upper side of said base member (40) and the clamping boss(610) is formed at the bottom side of sub-walker unit (20), the rotation prevention means (60) can be configured with a first and a second concavo-convex parts (620, 630) that are formed around said clamping boss (610) and said insertion hole (600) and interlocked with each other when the sub-walker unit (20) is installed on the upper side of the base member (40).

Here, the insertion hole (600) is formed on the base member (40) with the clamping boss (610) on the sub-walker unit (20). However, it is only one of example and it would be obvious to the people with ordinary skill in the art of the present invention that the clamping boss is formed on the base member (40) with the insertion hole on the sub-walker unit (20) although its configuration has not been shown in the figure.

The reference numeral 640 indicates the clamping bolt that is clamped with the screw hole formed along the length of the clamping boss (610) and used to firmly maintain the removal interconnection between the base member (40) of the main walker unit (10) and the sub-walker unit (20).

Also, the rotation prevention means (60) mentioned above not only prevents the rotation, but brings the effect of changing the interconnection angle between the main walker unit (10) and the sub-walker unit (20) in accord with the physical characteristics of the sub-walker.

Since the weight of sub-walker wearing the sub-walker unit (20) is applied to the main walker, it is necessary to disperse the load applied to the main walker. For this, it is preferable to install the support member (50) at the end part of the base member (40) in the opposite direction of the body member (100) as shown in FIG. 1 to support the load applied downward from the sub-walker unit (20).

Moreover, it is preferable to install the wheel (520) at the bottom of the support member (50) as shown in FIG. 4 to support the easy walking of the main walker even under the weight of the sub-walker.

The support member (50) in FIG. 4 includes the support fixture (500) with the frames in the perpendicular and horizontal directions. On the horizontal frame of said support fixture (500) is formed the insertion slot (500a) to which the end part of the base member (40) is inserted. The through hole (500b) is formed on the horizontal frame and penetrates the insertion slot (500a) perpendicularly. Said base member (40) has the through hole (400) formed at the end part corresponding to said through hole (500b). As the end part of the base member (40) is inserted into the insertion slot (500a), said through holes (500b, 400) are aligned with each other at which the base member (40) and the support fixture (500) are firmly interconnected by the clamping bolt (540) and the clamping nut (540′).

Although the preferred embodiments have been described in the above with reference to the drawings, it is understood that various equivalent modifications and variations of the embodiments can be included in the scope of the present invention as recited in the claims.

### INDUSTRIAL APPLICABILITY

The present invention relates to a walking assist device and more particularly, can be applied for the walking assist device by which a main walker who has no inconvenience in walking can help an inconvenient sub-walker take the walking practice.

What is claimed is;:

1. A walking assist device comprising; a main walker unit having a body member with a hollow portion in which a main walker's foot can be penetrated and fixed; and a sub-walker unit that is interconnected with said main walker unit and fixes a sub-walker's foot.

2. The walking assist device of claim 1, wherein said main walker unit is provided with a harness that can adjust said hollow portion size of said body member to be fit for a main walker's foot.

3. The walking assist device of claim 1, wherein said main walker unit is provided with a base member that protrudes into one side of said body member, and said sub-walker unit is installed on the upper side of the same.

4. The walking assist device of claim 3, wherein a support member is installed at the end part of said base member in the opposite direction of said body member and supports the load applied downward from said sub-walker unit.

5. The walking assist device of claim 3, wherein a rotation prevention means is provided between the bottom side of said sub-walker unit and the upper side of the base member of said main walker unit so as to prevent the relative rotation between the sub-walker unit and the main walker unit after the sub-walker unit has been installed at the upper side of the base member.

6. The walking assist device of claim 5, wherein a clamping boss or an insertion hole are formed at the bottom side of said sub-walker unit while the clamping boss or the insertion hole are formed at the upper side of said base member corresponding to said clamping boss or said insertion hole, said rotation prevention means being configured with a first and a second concavo-convex parts that are formed around said clamping boss and said insertion hole and interlocked with each other when the sub-walker unit is installed on the upper side of the base member.

7. The walking assist device of claim 2, wherein said harness is provided with a housing that is installed on the body member while covering one side cut out of the body member of said main walker unit with a through screw hole formed at one side, a adjust bolt that is inserted into the through screw hole of said housing and moves forward and backward through one side cut out of the body member, and a pressure plate that is interconnected with the end part of said adjust bolt and gets in touch with the one side of the user's foot as said adjust bolt is tightened.

8. The walking assist device of claim 4, wherein a wheel is installed at the bottom of said support member.
